(19) United States
(12) Patent Application Publication
(10) Pub. No.: US 2005/0001527 A1
(43) Pub. Date: Jan. 6, 2005

(54) Plasma processing apparatus

(76) Inventor: Akira Sugiyama, Tenri-shi (JP)

Correspondence Address: EDWARDS & ANGELL, LLP, P.O. BOX 55874, BOSTON, MA, 02205, US

(21) Appl. No.: 10/787,037

(22) Filed: Feb. 24, 2004

(30) Foreign Application Priority Data
Feb. 24, 2003 (JP) 2003-046297(P)

(51) Int. Cl. H01J 7/24; H01J 17/26; H01J 61/28

(52) U.S. Cl. 313/231.31; 315/111.21; 313/231.01; 118/723 R

(57) ABSTRACT

A plasma processing apparatus has coated surfaces opposing to a surface to be processed of a substrate, and includes electrodes adjacent to each other and a dielectric filled between the electrodes and covering the coated surfaces. The dielectric has first and second opposing surfaces. The plasma processing apparatus further includes a gas supply line having a gas supply opening provided on the first opposing surface and supplying a processing gas to the surface to be processed, and a gas exhaust line 16 having a gas exhaust opening provided on the second opposing surface and exhausting the processing gas supplied to the surface to be processed.

This nonprovisional application is based on Japanese Patent Application No. 2003-046297 filed with the Japan Patent Office on Feb. 24, 2003, the entire contents of which are hereby incorporated by reference.

### BACKGROUND OF THE INVENTION

1. Field of the Invention

The present invention generally relates to a plasma processing apparatus and, more specifically, to a plasma processing apparatus used for improving surface quality, cleaning, processing and film formation during manufacturing of semiconductors, flat panel displays including liquid crystal display devices, electro luminescence (EL) and plasma displays (PDP), as well as solar cells.

2. Description of the Background Art

Conventionally, in the process of manufacturing semiconductors, flat panel displays and solar cells, plasma generated under reduced pressure is utilized for improving surface quality, cleaning, and processing of and film formation on glass substrates or semiconductor wafers. Recently, because of intensified competition of cost reduction, atmospheric plasma technique that does not require large-scale facilities such as a vacuum chamber and an evacuating apparatus has attracting attention. In some processes such as improving surface quality and cleaning, a plasma processing apparatus utilizing atmospheric plasma technique has been introduced for practical application.

A normal pressure plasma processing apparatus utilizing the atmospheric plasma technique is disclosed in Japanese Patent Laying-Open No. 2002-151494. FIG. 15 is a cross section showing the normal pressure plasma processing apparatus disclosed in Japanese Patent Laying-Open No. 2002-151494. FIG. 16 is a bottom view of the normal pressure plasma processing apparatus shown in FIG. 15.

Referring to FIGS. 15 and 16, the normal pressure plasma processing apparatus includes a power supply (high voltage pulse power supply) 201, electrodes 202 and 203, a solid dielectric 204, a gas outlet 205, a processing gas introduction port 207, an inner circumferential exhaust gas cylinder 210, an outer circumferential exhaust gas cylinder 211, an inert gas inlet 212, and an inert gas outlet pore 213. Below the normal pressure plasma processing apparatus, a carry-in belt 241, a processing portion belt 242 and a carrying-out belt 243 are provided. An object 214 to be processed passes below gas outlet 205 while it is conveyed by processing portion belt 242.

The processing gas is introduced from processing gas inlet 207 to a vessel formed of solid dielectric 204. By applying a pulse electric field to electrodes 202 and 203 arranged outside solid dielectric 204, the processing gas that passes between electrodes 202 and 203 is turned to plasma. The processing gas is blown out from gas outlet 205 to object 214 of processing as a plasma gas. Thereafter, the processing gas is recovered through inner circumferential exhaust gas cylinder 210.

The inert gas introduced from inert gas inlet 212 is blown out from inert gas outlet pore 213 to a downward position where object of processing 214 is positioned. As the inert gas serves as a gas curtain, the atmosphere around the object of processing 214 is kept as an inert gas atmosphere. The inert gas is recovered mainly from outer circumferential gas cylinder 211.

In the normal pressure plasma processing apparatus disclosed in Japanese Patent Laying-Open No. 2002-151494, electric field strength is the highest between electrodes 202 and 203, and therefore, plasma generation is most likely at this position. Therefore, the processing gas is turned to plasma while it passes between electrodes 202 and 203, and thereafter blown toward the object of processing 214 as a plasma gas. As the position where the processing gas is turned to plasma is away from the object 214 to be processed, there arises a problem that efficiency of plasma processing becomes lower. Further, this arrangement is not preferable either, from the viewpoint of utilizing power to be applied to electrodes 202 and 203 for plasma processing with high efficiency.

In order to improve efficiency of plasma processing, it may be possible to make smaller the space between electrodes 202 and 203 and the object of processing 214. When such an arrangement is installed in the normal pressure plasma processing apparatus disclosed in Japanese Patent Laying-Open No. 2002-151494, however, the surface to be processes of object 214 may suffer from ion damages or charge-up damages.

In the normal pressure plasma processing apparatus disclosed in Japanese Patent Laying-Open No. 2002-151494, for the purpose of protecting the object of processing 214 from contaminating atmosphere such as oxidation atmosphere, an inert gas is blown thereto. Therefore, the running cost of the normal pressure plasma processing apparatus, particularly the cost of gas, increases.

Further, the apparatus for blowing the inert gas has a rather large structure around the electrodes. Therefore, it is difficult to realize multihead-electrode structure, in which a plurality of electrode sets are provided. Therefore, it is impossible to improve efficiency of plasma processing by installing multihead-electrodes.

Further, in the structure of the normal pressure plasma processing apparatus disclosed in Japanese Patent Laying-Open No. 2002-151494, electromagnetic wave tends to leak around electrodes 202 and 203, which electromagnetic wave may have undesirable influence on peripheral devices or humane body.

### SUMMARY OF THE INVENTION

Therefore, an object of the present invention is to solve the above described problems and to provide a plasma processing apparatus having high safety and capable of efficiently processing a surface of an object in a desired state.

The present invention provides a plasma processing apparatus generating plasma under atmospheric pressure for processing an object. The plasma processing apparatus includes first and second electrodes adjacent to each other and having coated surfaces facing a surface of the object to be processed, and a dielectric filled between the first and second electrodes and covering the coated surfaces. The dielectric has a first opposing surface positioned spaced apart from the surface of the object between the object and the first electrode and a second opposing surface positioned spaced apart from the surface of the object between the object and the second electrode. The plasma processing apparatus further includes gas supplying means having a supply opening formed on the first opposing surface for supplying a processing gas to the surface of the object through the supply opening, and gas exhausting means having an exhaust opening formed on the second opposing surface for exhausting the processing gas supplied to the surface of the object through the exhaust opening.

In the plasma processing apparatus structured in this manner, when a voltage is applied between the first and second electrodes, a plasma generates in a space between the surface of the object of processing and the dielectric, at a position where the first and second electrodes are placed next to each other. Here, until the processing gas supplied through the supply opening provided on the first opposing surface to the surface of the object is exhausted from the surface of the object through the exhaust opening provided on the second opposing surface, the processing gas moves over the surface of the object, with the space between the surface of the object and the dielectric serving as a gas flow path. The plasma generates mainly at the region between the first and second opposing surfaces, and therefore, the processing gas passes through the position where the plasma is generating. As a result, the processing gas is turned to plasma, and the object is processed. It is noted that the atmospheric pressure refers to the pressure range of 1013.25×10⁻¹(hPa) to 1013.25×10 (hPa).

In the present invention, the dielectric is provided to fill between the first and second electrodes, and therefore, plasma does not generate between the first and second electrodes. Further, as the dielectric is provided to cover the coated surfaces opposing to the surface of the object, discharge is not concentrated at a portion where the first and second electrodes are closest to each other. From these reasons, stable plasma can be generated on the surface of the object to be processed. As the plasma is generated at a position close to the surface of the object to be processed, efficiency of plasma processing can be improved.

Preferably, the gas supplying means is provided inside the first electrode, and the gas exhausting means is provided inside the second electrode. In the plasma processing apparatus structured in this manner, the potential is the same inside the first and second electrodes, and therefore, even when processing gas exists in the gas supplying means and the gas exhausting means, plasma or abnormal discharge does not occur. Therefore, power applied to the first and second electrodes can be utilized efficiently for generating plasma at the surface of the object. Further, the size of the apparatus can be reduced as compared with an apparatus having the gas supplying means and the gas exhausting means provided outside the electrodes.

Preferably, around the gas supplying means and the gas exhausting means, an inner wall formed of a dielectric material is provided. In the plasma processing apparatus structured in this manner, generation of plasma or abnormal discharge at the gas supplying means and the gas exhausting means can surely be prevented.

Preferably, the coated surfaces of the first and second electrodes, respectively, extend on a plane parallel to the surface of the object. In the plasma processing apparatus structured in this manner, at a position on the surface of the object from the coated surface of the first electrode to the coated surface of the second electrode is the position where the electric field is the strongest. Therefore, generation of plasma is most likely at this position.

Preferably, an electric line of force connecting the first and second electrodes when a voltage is applied between said first and second electrodes extends above and substantially parallel to the surface of the object. In the plasma processing apparatus structured in this manner, electrons or ions that accelerate along the electric line of force do not proceed toward the surface of the object. Therefore, ion damages or charge-up damages on the surface of the object caused by the plasma generated on the surface of the object can be suppressed.

Preferably, the supply opening and the exhaust opening are provided in a vicinity of a region positioned between the first opposing surface and the second opposing surface. In the plasma processing apparatus structured in this manner, plasma generates mainly at the region positioned between the first opposing surface and the second opposing surface. Therefore, by providing the supply opening and the exhaust opening near this region, the processing gas can more surely be supplied to the position where the plasma generates.

Preferably, the dielectric includes a recessed portion formed such that distance from the surface of the object to the second opposing surface is made larger than distance from the surface of the object to the first opposing surface. In the plasma processing apparatus structured in this manner, the recessed portion is formed on the second opposing surface where the exhaust opening is provided, and therefore, conductance on the side of the exhaust opening of the processing gas can be increased. Therefore, the supplied processing gas can positively be led to the side of the exhaust opening.

Preferably, the supply opening and the exhaust opening are formed to have a slit-shape extending in one direction or formed as a plurality of pores arranged in one direction. In the plasma processing apparatus structured in this manner, it becomes possibly to uniformly deliver the processing gas over a wide range of the surface of the object. Accordingly, uniform plasma processing of the object surface becomes possible.

Preferably, the gas supplying means and the gas exhausting means are formed such that total flow rate of gas exhausted through said exhaust opening is not smaller than total flow rate of the processing gas supplied through the supply opening. In the plasma processing apparatus structured in this manner, from the exhaust opening, atmospheric air around the object is exhausted; in addition to the processing gas supplied to the surface of the object. Thus, leakage of the processing gas from the space between the object surface and the dielectric can be prevented. Further, it is unnecessary to blow an inert gas or the like toward the surface of the object in order to protect the object from contaminating atmosphere. Therefore, the apparatus can be made smaller and the cost of the gas used for the apparatus can be reduced.

Preferably, at that portion of the dielectric which faces the surface of the object, where distance between an end portion of the dielectric positioned at a shortest distance from the supply opening and the supply opening is represented by L1, distance between the supply opening and the exhaust opening is represented by L2, and distance between the exhaust opening and an end portion of the dielectric positioned at a shortest distance from the exhaust opening is represented by L3, L1, L2 and L3 satisfy the relations of 4≦L1/L2≦1000 and 4≦L3/L2≦1000. In the plasma processing apparatus structured in this manner, it becomes possible to supply larger amount of processing gas to a plasma generating position closer to the exhaust opening when viewed from the supply opening and to exhaust larger amount of processing gas from the exhaust opening. Further, unnecessary increase in size of the first and second electrodes can be prevented.

Preferably, the plasma processing apparatus further includes a grounded conductive cover provided to cover externally exposed surfaces of the first and second electrodes. In the plasma processing apparatus structured in this manner, leakage of electromagnetic wave from the first and second electrodes can be prevented. Thus, very safe plasma processing apparatus can be provided.

Preferably, the plasma processing apparatus further includes a third electrode positioned next to the second electrode on a side opposite to the first electrode with respect to the second electrode. The plasma processing apparatus is formed in symmetry with respect to the second electrode. In the plasma processing apparatus structured in this manner, electric fields formed externally by the first, second and third electrodes cancel each other. Therefore, a safer plasma processing apparatus can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross section showing a plasma processing apparatus in accordance with a first embodiment of the present invention.

FIG. 2 is a cross sectional view taken along the line II-II of FIG. 1.

FIG. 3 is a bottom view showing the plasma processing apparatus viewed from the direction of the arrow III of FIG. 1.

FIG. 4 is a bottom view of the plasma processing apparatus showing a modification of the gas supply opening and gas exhaust opening shown in FIG. 3.

FIG. 5 is a cross section showing, in schematic enlargement, the vicinity of the plasma generating region shown in FIG. 1.

FIG. 6 is a cross section showing a plasma processing apparatus in accordance with a second embodiment of the present invention.

FIG. 7 is a cross sectional view taken along the line VII-VII of FIG. 6.

FIG. 8 is a bottom view of the plasma processing apparatus viewed from the direction of the arrow VIII-VIII of FIG. 6.

FIG. 9 is a bottom view of the plasma processing apparatus showing a modification of the gas supply opening and gas exhaust opening shown in FIG. 8.

FIG. 10 is a cross section showing, in schematic enlargement, the vicinity of the plasma generating region shown in FIG. 6.

FIG. 11 is a cross section showing a manner how the processing gas moves over the surface to be processed.

FIG. 12 is a cross section showing a plasma processing apparatus in accordance with a third embodiment of the present invention.

FIG. 13 is a cross section showing a plasma processing apparatus in accordance with a fourth embodiment of the present invention.

FIG. 14 is a cross section showing a plasma processing apparatus in accordance with a fifth embodiment of the present invention.

FIG. 15 is a cross section showing a plasma processing apparatus disclosed in Japanese Patent Laying-Open No. 2002-151494.

FIG. 16 is a bottom view of the normal pressure plasma processing apparatus shown in FIG. 15.

### DESCRIPTION OF THE PREFERRED EMBODIMENTS

Embodiments of the present invention will be described with reference to the figures.

(First Embodiment)

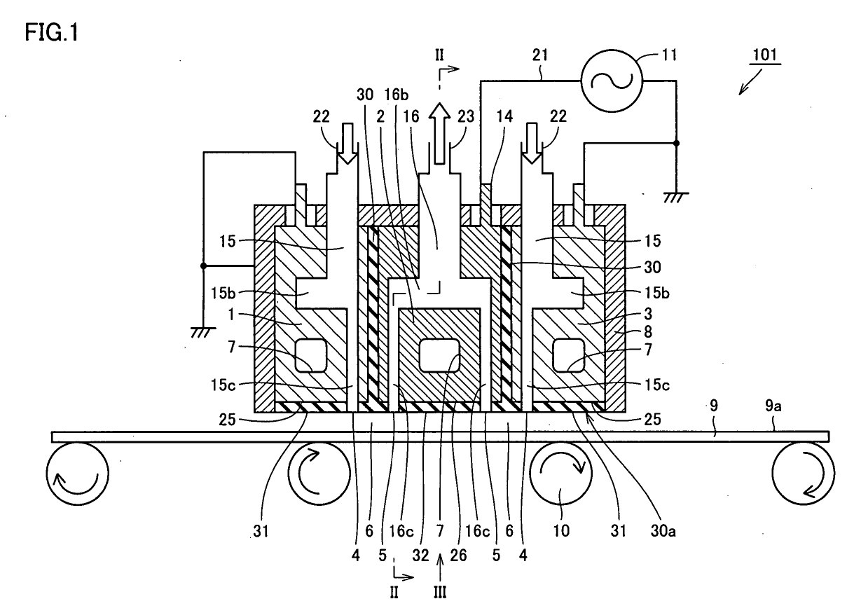

Referring to FIG. 1, a plasma processing apparatus 101 includes electrodes 1, 2, 3 arranged parallel to a surface 9a to be processed of a substrate 9, a dielectric 30 partially covering surfaces of electrodes 1, 2 and 3, a gas supply line 15 formed inside electrodes 1 and 3, and a gas exhaust line 16 formed inside electrode 2.

Electrodes 1, 2 and 3 are arranged spaced from each other such that electrode 2 is positioned between electrodes 1 and 3. Electrodes 1, 2 and 3 are formed to be in symmetry about the centerline of electrode 2. Electrodes 1 and 3 have coated surfaces 25 facing the surface 9a of substrate 9 to be processed, and electrode 2 similarly has a coated surface 26 facing the surface 9a of substrate 9 to be processed. Coated surfaces 25 and 26 extend on a plane parallel to the surface 9a to be processed of substrate 9.

On the top surface side of electrode 2, a power introducing portion 14 is provided. Power introducing portion 14 is connected through a power transmission path 21 to a high frequency power supply 11. Electrodes 1 and 3 are grounded on the topside.

It is noted that in place of high frequency power supply 11, a pulse power supply may be provided, or these two power supplies may be switched or installed together. The means for supplying power must be carefully determined in consideration of frequency and repetition frequency, as well as conditions required for processing, limitation of processing gas, required processing ability and extent of damage to the surface to be processed. In the present embodiment, a high frequency power supply refers to one having the frequency of at least 10 (Hz) to at most 100 (GHz), and a pulse power supply refers to one having repetition frequency of at most 10 (MHz), rising time of the waveform of at most 100 (μsec) and the pulse application time of at most 100 (msec).

A dielectric 30 is provided filled between electrodes 1 and 2 and between electrodes 2 and 3 and covering surfaces 25 and 26. Dielectric 30 has an opposing surface 30a that faces the surface 9a of substrate 9 to be processed. Opposing surface 30a includes a first opposing surface 31 formed between electrodes 1, 3 and substrate 9, and a second opposing surface formed between electrode 2 and substrate 9. Opposing surface 30a extends on a plane parallel to and spaced apart from surface 9a to be processed of substrate 9.

A shield case 8 formed of a conductive material is provided to cover externally exposed surfaces of electrodes 1 and 3. Shield case 8 is grounded.

When a voltage is applied between electrodes 1 and 2 and between electrodes 2 and 3 by high frequency power supply 11, plasma generates in a space between surface 9a to be processed of substrate 9 and dielectric 30, mainly at a plasma generating region 6 positioned between the first and second opposing surfaces 31 and 32. Here, as dielectric 30 fills between electrodes 1 and 2 and between electrodes 2 and 3, plasma does not generate at these portions.

Dielectric 30 may be formed directly on the surfaces of electrodes 1 to 3 by spraying or anodization. In view of labor and cost for maintenance, however, dielectric may preferably be formed detachably on electrodes 1 to 3. Thickness of dielectric 30 between electrodes 1 and 2 and between electrodes 2 and 3 is determined in consideration of frequency of high frequency power supply 11, repetition frequency of pulse power supply provided in place of high frequency power supply 11, type of processing gas, and material characteristics of dielectric 30 with respect to the plasma. Generally, thickness of the dielectric between electrodes 1 and 2 and between 2 and 3 should preferably be 10 mm or thinner, and when the frequency of high frequency power supply 11 is 1 (MHz) or higher, the thickness should more preferably be 2 mm or thinner.

Similarly, the thickness of dielectric 30 between coated surfaces 25, 26 and opposing surface 30a will be considered. When the thickness is made as small as possible, electric field strength at plasma generating region 6 can be increased. When the thickness is made too small, however, strength of dielectric 30 would be insufficient and it would possibly be broken. Therefore, practical thickness of dielectric 30 between coated surfaces 25, 26 and opposing surface 30a is, preferably, at least 0.1 mm and at most 10 mm. When dielectric 30 is directly formed on electrodes 1 to 3, thickness of dielectric 30 may be smaller than the range mentioned above.

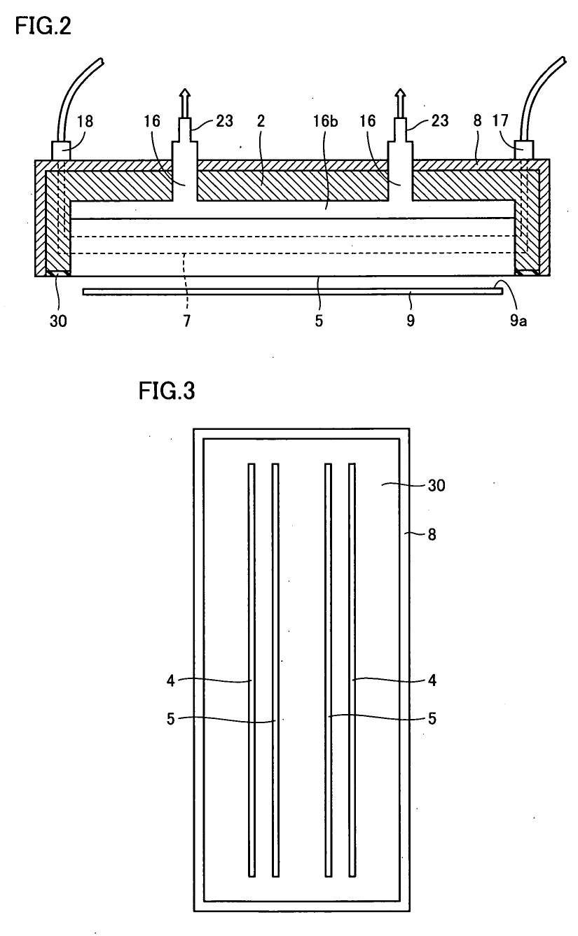

Referring to FIGS. 1 and 2, electrodes 1 to 3 and dielectric 30 are formed to have a width wider by about 20% than the width of substrate 9. Inside the electrode 2, a gas exhaust line 16 is formed, of which inner wall is defined by electrode 2. Gas exhaust line 16 extends from the top surface of electrode 2 to coated surface 26 and further to reach the second opposing surface 32 of dielectric 30. Gas exhaust line 16 includes, inside electrode 2, a gas pool portion 16b extending in a direction vertical to the sheet of the drawing, and a slit-shaped flow path 16c branching at gas pool portion 16b into two and reaching the second opposing surface 32.

Inside the electrodes 1 and 3, a gas supply line 15 is formed, of which inner wall is defined by electrodes 1 and 3. Gas supply line 15 extends from the top surface of electrodes 1 and 3 to coated surface 25 and further to reach the first opposing surface 31 of dielectric 30. Gas supply line 15 includes, inside electrodes 1 and 3, a gas pool portion 15b extending in a direction vertical to the sheet of the drawing, and a slit-shaped flow path 15c extending from gas pool portion 16b to reach the first opposing surface 31.

As the gas supply line 15 and gas exhaust line 16 are formed inside the electrodes, it becomes possible to reduce the size of plasma processing apparatus 101.

Gas supply line 15 has a gas introducing portion 22 formed on the top surface side of electrodes 1 and 3. Gas introducing portion 22 is connected to a gas cylinder or a gas tank, not shown. Gas exhaust line 16 has a gas exhausting portion 23 formed on the top surface side of electrode 2. Gas exhausting portion 23 is connected to a suction pump, not shown.

Referring to FIGS. 1 to 3, gas exhaust line 16 forms a gas exhaust opening 5 at the second opposing surface 32 of dielectric 30. Further, gas supply line 15 forms a gas supply opening 4 at the first opposing surface 31 of dielectric 30. Gas exhaust opening 5 and gas supply opening 4 are formed to have a slit-shape extending in one direction. Referring to FIGS. 2 and 3, gas exhaust opening 5 and gas supply opening 4 are formed to have approximately the same or larger width than that of substrate 9. As gas exhaust opening 5 and gas supply opening 4 are formed in this manner, it is possible to supply the processing gas entirely to the surface 9a of the object to be processed, and to surely recover the processing gas from the surface 9a.

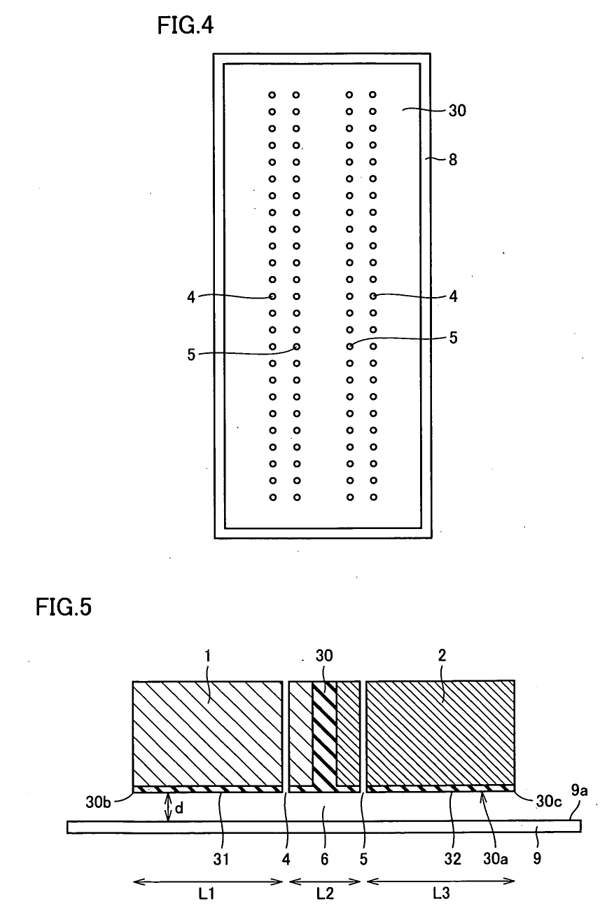

Referring to FIG. 4, gas supply opening 4 and gas exhaust opening 5 may be formed as small pores arranged in one direction. In that case, electrodes 1 to 3 would have small pores formed in the same shape as gas supply opening 4 and gas exhaust opening 5, in place of slit-shaped flow path portions 15c and 16c. It is noted that gas supply opening 4 and gas exhaust opening 5 may be formed by appropriately combining the shapes shown in FIGS. 3 and 4.

Referring to FIGS. 1 and 2, a coolant flow path 7 is formed in electrodes 1 to 3. The coolant flow path 7 forms a path that extends from the top surface side of the electrode through the inside of the electrode and again reaching the top surface side of the electrode. At the position where coolant flow path 7 reaches the top surface of the electrode, a coolant introducing portion 17 and a coolant exhausting portion 18 are provided. In order to supply a coolant to coolant flow path 7, coolant introducing portion 17 and coolant exhausting portion 18 are connected to a cooler or a heater, not shown. The coolant introduced to coolant flow path 7 serves to cool electrodes 1 to 3 and dielectric 30 of which temperature has been elevated.

As a means for conveying substrate 9, a plurality of conveyer rollers 10 are provided. A stage or a substrate holder may be used as another means for conveying substrate 9. When a stage or a holder is used, it becomes possible to draw ions to substrate 9 by grounding, or by applying a DC or AC bias voltage. Accordingly, speed and quality of plasma processing may be improved dependent on the type of processing. When substrate 9 is not conveyed during plasma processing, local processing is also possible.

Next, steps of processing substrate 9 using the plasma processing apparatus shown in FIG. 1 will be described.

Referring to FIG. 1, different types of gases introduced from gas cylinders or gas tanks, not shown, are mixed by mass flow or, in some cases, by a mixer. The thus mixed gas is introduced as the processing gas from gas introducing portion 22 to gas supply line 15 with high pressure. The processing gas proceeds in the direction vertical to the sheet surface at gas pool portion 15b. As the processing gas passes through slit-shaped flow path portion 15c having a small cross sectional area, the flow velocity is accelerated, and the processing gas is then blown out from gas supply opening 4 to surface 9a to be processed of substrate 9.

At this time, the processing gas passes through the inside of electrodes 1 to 3. In electrodes 1 and 3, there is no potential difference. Therefore, in principle, plasma or abnormal discharge never occurs in gas supply line 15. It is possible to more securely prevent generation of plasma or abnormal discharge in gas supply line 15, by setting the path of gas supply line 15 smooth and by rounding a corner near gas pool portion 15b.

Assume that plasma processing for improving surface quality of substrate 9 is performed. In that case, a mixed gas of helium, argon, oxygen and air is used as the processing gas. The processing gas used may differ dependent on the type of processing, and therefore, it is necessary to appropriately select the types and mixing ratio of the gases to be mixed.

The processing gas blown to the surface 9a of substrate 9 to be processed moves from the side of first opposing surface 31 over plasma generating region 6, and reaches the side of second opposing surface 32 where gas exhaust opening 5 is provided. Thereafter, the processing gas is recovered through gas exhaust opening 5 through gas exhaust line 16 to a suction pump, not shown.

Here again, there is no potential difference in electrode 2, and therefore, plasma or abnormal discharge never occurs in gas supply line 16. Further, it is also preferable that the path of gas exhaust line 16 is set smooth and the corner near gas pool portion 16b is rounded, similar to gas supply line 15.

The high frequency power output from high frequency power supply 11 is applied through power transmission path 21 and power introducing portion 14 to electrode 2. An electric field is formed between electrode 2 to which the high frequency power is applied and the grounded electrodes 1 and 3. The electric field becomes the strongest at plasma generating region 6 positioned between the first and second opposing surfaces 31 and 32 in the space between the surface 9a to be processed of substrate 9 and dielectric 30. Therefore, the processing gas moving over the surface 9a to be processed of substrate 9 is turned to plasma at the position centered around plasma generating region 6.

The plasma contacts the surface 9a to be processed of substrate 9 that has been conveyed by conveyer roller 10. By accelerated reaction caused by active species or by physical etching effect caused by ions, plasma processing such as improvement of surface quality, cleaning, processing or film formation is effected on substrate 9. Even when the plasma is not brought into contact with surface 9a to be processed, plasma processing is possible by diffused active species or ions. It is noted, however, that when the plasma is brought into contact with surface 9a, a sheath (space charge layer) can be formed at the interface between the surface 9a to be processed and the plasma. Thus, plasma processing at higher speed becomes possible.

Generally, in plasma processing, there is a concern of physical damage or charge-up damage to the surface 9a of substrate 9. In plasma processing apparatus 101 in accordance with the present invention, however, coated surface 25 of electrode 1 and coated surface 26 of electrode 2 extend on a plane parallel to the surface 9a to be processed. Therefore, the electric line of force formed between electrodes 1 and 2 and between electrodes 2 and 3 extend above and parallel to the surface 9a.

Therefore, ions or electrodes that are accelerated along the electric line of force do not move toward the surface 9a to be processed. Consequently, an attack by ions or electrons on the surface 9a to be processed becomes softer, suppressing charge-up damage. When a process with still lighter damage is desired at the expense of processing speed, the process should be performed without bringing the plasma into contact with the surface 9a to be processed.

In the plasma processing performed in this manner, it is important to stably generate plasma and to efficiently use the processing gas in order to improve processing capability and to decrease running cost. Therefore, in order to supply the processing gas to plasma generating region 6 with high efficiency and to evacuate the processing gas from plasma generating region 6 with high efficiency, it becomes necessary to appropriately control flow rate and flow velocity of the processing gas.

Referring to FIG. 5, plasma generating region 6 is shown positioned between electrodes 1 and 2. In the example of FIG. 5, it is assumed that dielectric 30 has an end portion 30b on the side of the first opposing surface 31 and another end 30c at the side of the second opposing surface 32, of opposing surface 30a. Here, the distance from end 30b to gas supply opening 4 is denoted by L1, the distance from gas supply opening 4 to gas exhaust opening 5 is denoted by L2, the distance from gas exhaust opening 5 to end 30c is denoted by L3 and the distance from opposing surface 30a to surface 9a to be processed is denoted by d.

The processing gas supplied from gas supply opening 4 to surface 9a to be processed moves separately to the direction where end 30b is positioned and to the direction where plasma generating region 6 is positioned. In order to direct a larger amount of the processing gas to plasma generating region 6 and to recover the processing gas from gas exhaust opening 5 with higher efficiency, determination of the cross section S of the space through which the processing gas passes over the surface 9a to be processed and determination of the distance L are important. The flow of processing gas under atmospheric pressure is considered to be a viscous flow, and therefore, these parameters and the conductance U as an index representing how easily the processing gas flows satisfy the relation given by equation (1) below. It is noted that the length of the space in the direction vertical to the sheet surface of FIG. 5 is assumed to be infinite.
U=A·S²/L (1)

Here, A in equation (1) is a constant defined by coefficient of viscosity and pressure of the processing gas.

The distance d from opposing surface 30a to the surface 9a to be processed is constant at any position. Therefore, it is understood from equation (1) that the distance L is the determining factor of conductance U.

In order to supply larger amount of processing gas to plasma generating region 6, it is necessary to make the distance L1 larger as compared with the distance L2. Here, the size of electrode 1 should not be excessively increased. Specifically, the distances L1 and L2 should preferably satisfy the relation of 4≦L1/L2≦1000. In order to supply the processing gas with still higher efficiency, the distances L1 and L2 should preferably satisfy the relation of 10≦L1/L2≦1000.

In order to recover the processing gas from gas exhaust opening 5 with high efficiency, it is necessary to make the distance L3 larger as compared with the distance L2. Here again, the size of electrode 2 should not be excessively increased. Specifically, the distances L2 and L3 should preferably satisfy the relation of 4≦L3/L2≦1000. In order to recover the processing gas from gas exhaust opening 5 with still higher efficiency, the distances L2 and L3 should preferably satisfy the relation of 10≦L3/L2≦1000.

Referring to FIG. 1, in the present embodiment, gas supply opening 4 and gas exhaust opening 5 are formed respectively for one plasma generating region 6. Further, gas supply opening 4 and gas exhaust opening 5 are provided in the vicinity of plasma generating region 6. Therefore, it is possible to direct large amount of processing gas to plasma generating region 6 and to recover processing gas from gas exhaust opening 5 with high efficiency.

Further, it is preferred that the total flow rate of the gas exhausted through gas exhaust line 16 is not smaller than the total flow rate of the processing gas supplied through gas supply line 15 to the surface 9a to be processed of substrate 9. Here, in addition to the processing gas supplied to the surface 9a, atmospheric air around the surface 9a is also exhausted from gas exhaust line 16. Thus, leakage of the processing gas from the space between opposing surface 30a and the surface 9a to be processed can be prevented.

There is a close relation between the flow velocity of the processing gas passing through plasma generating region 6 and the frequency of the applied high frequency power. By way of example, when the frequency of the high frequency power is small and the flow velocity of the processing gas is too fast, plasma excitation would be insufficient. On the contrary, when the flow velocity is too slow, the effect of cooling the dielectric would be insufficient, resulting in instable plasma or transition to arc discharge.

Plasma processing apparatus 101 in accordance with the first embodiment of the present invention generates plasma under atmospheric pressure for processing substrate 9 as an object of processing. Plasma processing apparatus 101 has coated surfaces 25 and 26 facing a surface of substrate 9 as the surface 9a to be processed, and includes electrodes 1 and 2 as the first and second electrodes positioned next to each other and a dielectric 30 filled between electrodes 1 and 2 and covering coated surfaces 25 and 26. Dielectric 30 has a first opposing surface 31 positioned between substrate 9 and electrode 1, spaced from the surface 9a to be processed of substrate 9, and a second opposing surface 32 positioned between substrate 9 and electrode 2, spaced from the surface 9a to be processed of substrate 9. Plasma processing apparatus 101 further includes a gas supply line 15 as a gas supplying means having a gas supply opening 4 as a supply opening provided at the first opposing surface 31, for supplying processing gas to the surface 9a to be processed of substrate 9 through gas supply opening 4, and a gas exhaust line 16 as a gas exhausting means having a gas exhaust opening 5 as an exhaust opening provided at the second opposing surface, for exhausting the processing gas supplied to the surface 9a to be processed of substrate 9 through gas exhaust opening 5.

Gas supply line 15 is provided in electrode 1, while gas exhaust line 16 is provided in electrode 2. Coated surfaces 25 and 26 of electrodes 1 and 2, respectively, extend in a plane parallel to the surface 9a of substrate 9. When a voltage is applied between electrodes 1 and 2, the electric line of force connecting electrodes 1 and 2 extends above and substantially parallel to the surface 9a of substrate 9.

Gas supply opening 4 and gas exhaust opening 5 are provided in the vicinity of plasma generating region 6 positioned between the first and second opposing surfaces 31 and 32. Gas supply opening 4 and gas exhaust opening 5 are formed in slit-shape extending in one direction or formed as a plurality of pores arranged in one direction.

Gas supply line 15 and gas exhaust line 16 are formed such that the total flow rate of gas exhausted through gas exhaust line 5 is not smaller than the total flow rate of the processing gas supplied through gas supply opening 4.

Plasma processing apparatus 101 further includes a shield case 8 as a grounded conductive cover, provided to cover externally exposed surfaces of electrodes 1 and 2. Plasma processing apparatus 101 further includes an electrode 3 as the third electrode, positioned next to electrode 2 and on the opposite side of electrode 1 with respect to electrode 2. Plasma processing apparatus is formed to be in symmetry with respect to the centerline of electrode 2.

In plasma processing apparatus 101 structured in this manner, it is possible to generate plasma mainly at plasma generating region 6 positioned close to the surface 9a as an object of processing. This enables highly efficient plasma processing of substrate 9. Further, plasma processing apparatus 101 has a symmetrical structure in which electrode 2, to which electric power is applied, is sandwiched by electrodes 1 and 3. Thus, electric fields formed outside electrodes 1 and 3 are cancelled by each other, and a plasma processing apparatus with small leakage of electromagnetic wave can be realized. In addition, a grounded shield case 8 is formed around electrodes 1 to 3, further preventing leakage of electromagnetic wave.

(Second Embodiment)

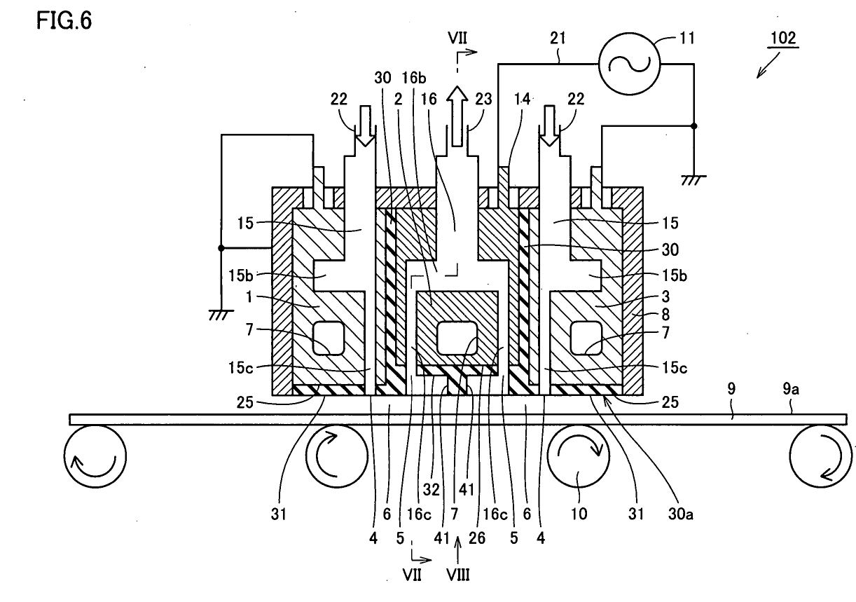

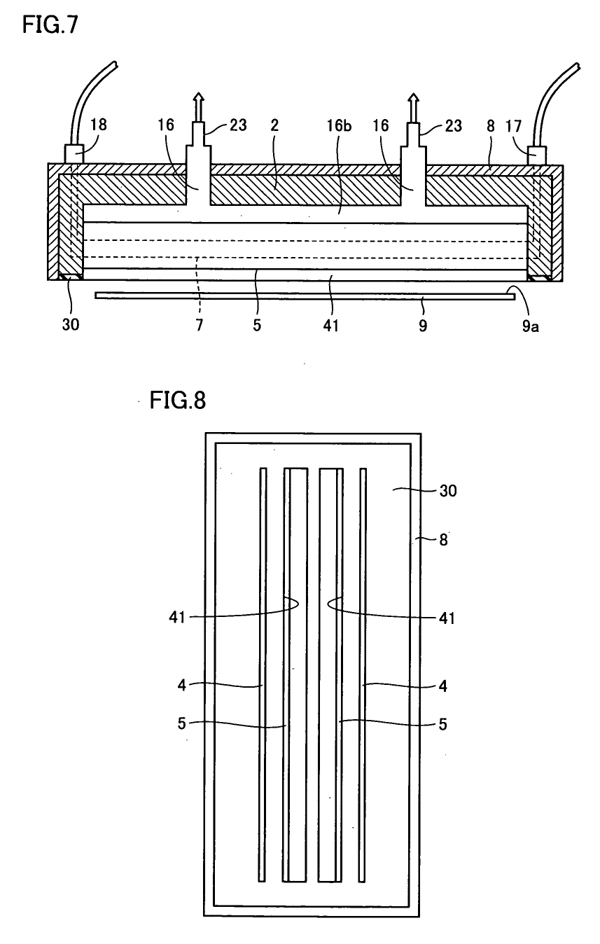

Referring to FIGS. 6 and 7, plasma processing apparatus 102 has basically the same structure as plasma processing apparatus 101 in accordance with the first embodiment. In the following, description of portions common to plasma processing apparatus 101 will not be repeated.

Dielectric 30 has an indented portion 41 at the position of the second opposing surface 32. The distance from the surface 9a to be processed of substrate 9 to the second opposing surface 32 positioned at the bottom surface of indented portion 41 is larger than the distance from the surface 9a to the first opposing surface 31. Gas exhaust line 16 reaches the second opposing surface 32 positioned at the bottom surface of indented portion 41.

Referring to FIG. 8, gas exhaust opening 5 and gas supply opening 4 are formed in slit-shape extending in one direction. Indented portion 41 is formed along the direction of extension of gas exhaust opening 5 and gas supply opening 4.

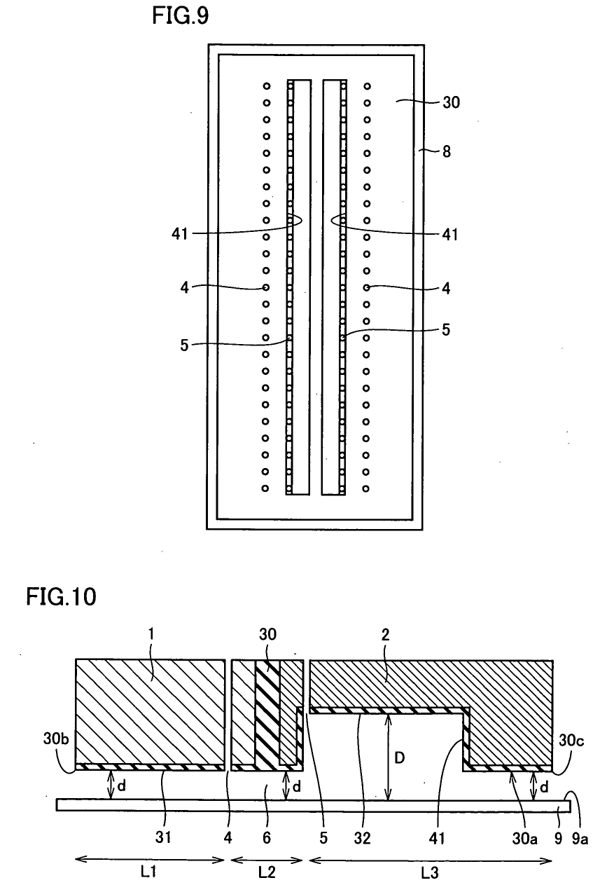

Referring to FIG. 9, as in the first embodiment, gas supply opening 4 and gas exhaust opening 5 may be formed as pores arranged in one direction.

FIG. 10 corresponds to FIG. 5 showing the first embodiment. Referring to FIG. 10, in addition to the distances L1, L2, L3 and d defined in FIG. 6, the distance from the second opposing surface 32 positioned at the bottom surface of indented portion 41 to the surface 9a to be processed will be denoted by D.

As is apparent from equation (1) described in connection with the first embodiment, by enlarging the distance from opposing surface 30a to the surface 9a to be processed, the conductance U of the processing gas can be increased. Here, the effect of increasing the conductance U is more noticeable than when the distance L is increased.

Therefore, by forming indented portion 41 that increases the distance from the second opposing surface 32 to the surface 9a to be processed from d to D, the conductance U of the processing gas on the side of gas exhaust opening 5 can significantly be increased.

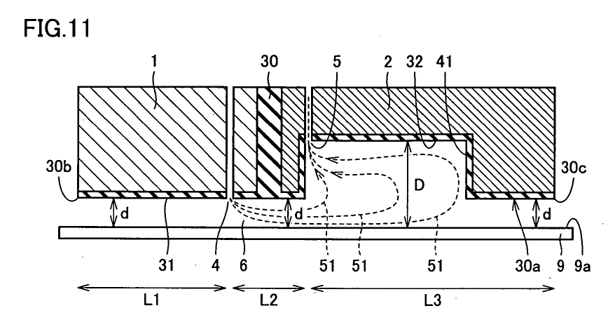

Referring to FIG. 11, as the conductance U of the processing gas increases on the side of gas exhaust opening 5 by the provision of indented portion 41, the processing gas that has been supplied from gas supply opening 4 to the surface 9a to be processed is directed efficiently to plasma generating region 6. The processing gas proceeds in indented portion 41 along the direction of the arrow 51, and recovered through gas exhaust opening 5.

In plasma processing apparatus 102 in accordance with the second embodiment of the present invention, dielectric 30 has indented portion 41 as a recessed portion, formed to increase the distance from the surface 9a to be processed of substrate 9 to the second opposing surface 32 to be larger than the distance from the surface 9a to be processed of substrate 9 to the first opposing surface 31.

Plasma processing apparatus 102 structured in this manner attains the effects of the first embodiment. In addition, it becomes possible to more positively drive the processing gas supplied to the surface 9a to be processed to plasma generating region 6. Thus, larger amount of processing gas can be turned to plasma at plasma generating region 6, and the efficiency of plasma processing can be improved.

(Third Embodiment)

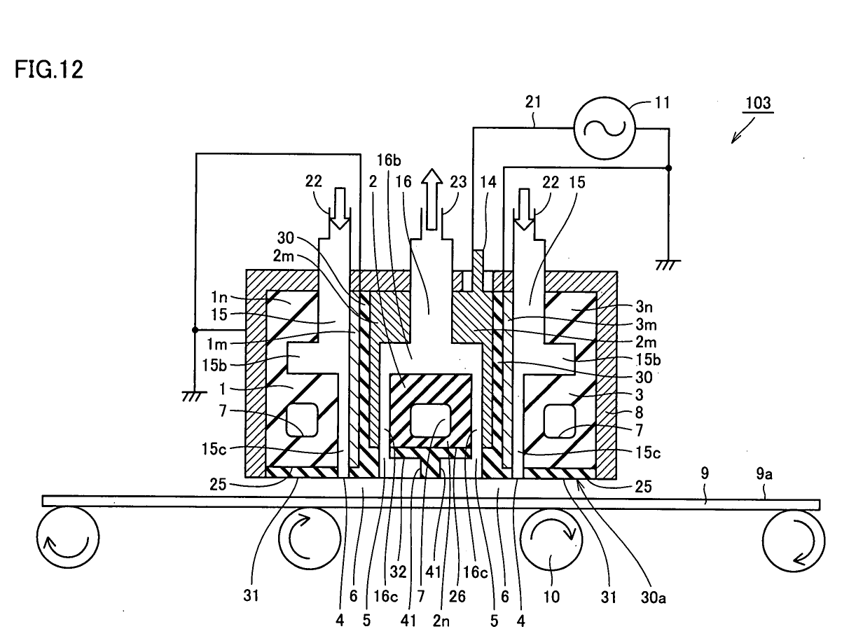

Referring to FIG. 12, plasma processing apparatus 103 has basically the same structure as plasma processing apparatus 102 in accordance with the second embodiment. In the following, description of portions common to plasma processing apparatus 102 will not be repeated.

Electrode 1 consists of a portion 1m positioned to the side of electrode 2 and a portion in positioned to the side opposite to electrode 2, with respect to gas supply line 15. Electrode 3 consists of a portion 3m positioned to the side of electrode 2 and a portion 3n positioned to the side opposite to electrode 2, with respect to gas supply line 15. Portions 1m and 1m are formed of a conductive material, and portions 1n and 3 n are formed of a dielectric material. Thus, part of gas supply line 15 is defined by portions 1n and 3n that are dielectric.

Electrode 2 consists of a portion 2m adjacent to electrodes 1 and 3 and a portion 2n surrounded by gas pool portion 16b and slit-shaped flow path portion 16c of gas exhaust line 16. Portion 2m is formed of a conductive material, and portion 2n is formed of a dielectric material. Thus, part of gas exhaust line 16 is defined by portion 2n that is dielectric.

Plasma processing apparatus 103 structured as described above attains the effects of the second embodiment. In addition, it becomes possible to more surely prevent generation of plasma or abnormal discharge at gas supply line 15 or gas exhaust line 16.

(Fourth Embodiment)

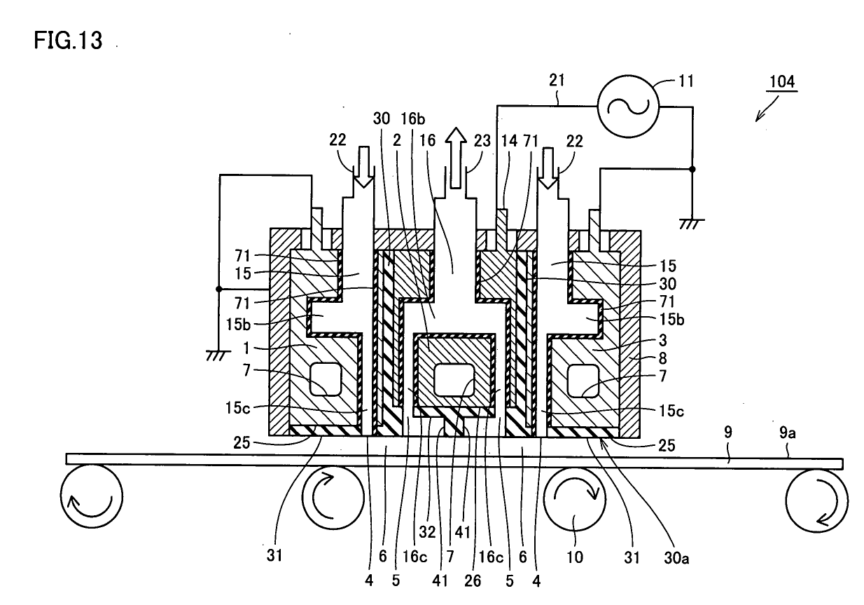

Referring to FIG. 13, plasma processing apparatus 104 has basically the same structure as plasma processing apparatus 102 in accordance with the second embodiment. In the following, description of portions common to plasma processing apparatus 102 will not be repeated.

On surfaces of electrodes 1 to 3 defining gas supply line 15 and gas exhaust line 16, an inner wall 71 of a dielectric material is formed. Therefore, gas supply line 15 and gas exhaust line 16 are fully covered by a dielectric, in electrodes 1 to 3.

In plasma processing apparatus 104 in accordance with the fourth embodiment of the present invention, inner wall 71 formed of a dielectric material is provided around gas supply line 15 and gas exhaust line 16.

Plasma processing apparatus 104 structured in the above described manner attains the effects of the second embodiment. In addition, it becomes possible to more surely prevent generation of plasma or abnormal discharge at gas supply line 15 or gas exhaust line 16.

(Fifth Embodiment)

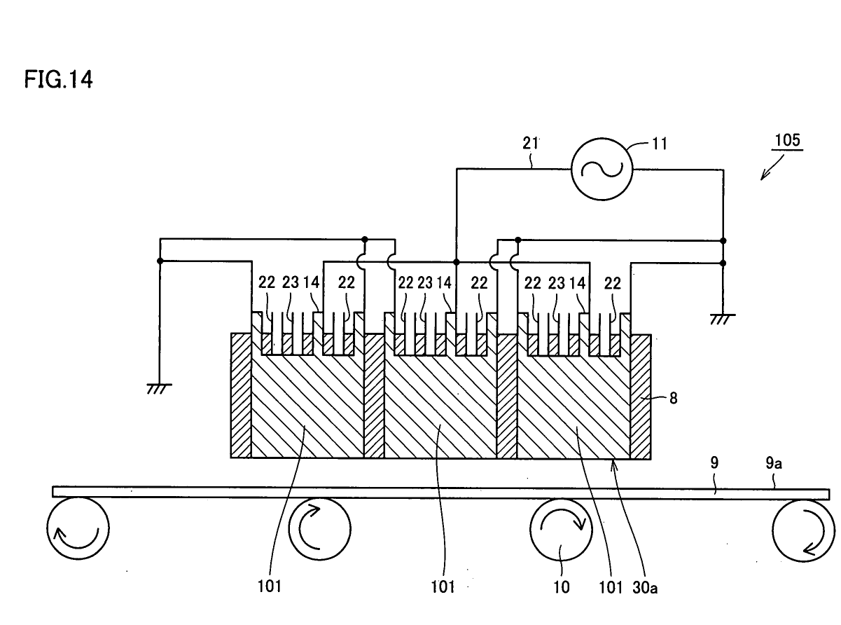

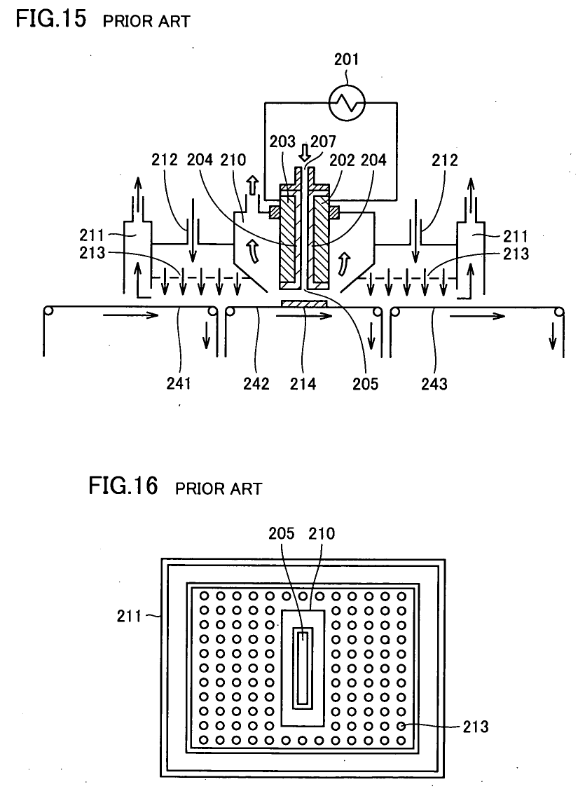

Referring to FIG. 14, plasma processing apparatus 105 includes a plurality of plasma processing apparatuses 101 in accordance with the first embodiment. On the surface 9a to be processed of substrate 9, opposing surface 30a of dielectric 30 extends over a wide area, above the surface 9a of substrate 9.

Electric power may be supplied from one power supply, or may be supplied separately to each of plasma processing apparatuses 101. When electric power is supplied separately to each of plasma processing apparatuses 101, plasma processing can advantageously be controlled apparatus by apparatus. Further, by changing composition of the processing gas to be supplied to plasma processing apparatuses one by one, it becomes possible to perform different types of processing by respective plasma processing apparatuses.

In plasma processing apparatus 105 structured as described above, the speed of plasma processing can be increased by increasing effective area of the region where plasma generates.

As described above, by the present invention, a plasma processing apparatus can be provided that is highly safe and is capable of efficiently processing a surface of an object in a desired state.

Although the present invention has been described and illustrated in detail, it is clearly understood that the same is by way of illustration and example only and is not to be taken by way of limitation, the spirit and scope of the present invention being limited only by the terms of the appended claims.

1. A plasma processing apparatus generating plasma under atmospheric pressure for processing an object, comprising:
first and second electrodes adjacent to each other and having coated surfaces facing a surface of the object to be processed;
a dielectric having a first opposing surface positioned spaced apart from the surface of the object between the object and said first electrode and a second opposing surface positioned spaced apart from the surface of the object between the object and said second electrode, filled between said first and second electrodes and covering said coated surfaces;
gas supplying means having a supply opening formed on said first opposing surface for supplying a processing gas to the surface of the object through said supply opening; and
gas exhausting means having an exhaust opening formed on said second opposing surface for exhausting the processing gas supplied to the surface of the object through said exhaust opening.

2. The plasma processing apparatus according to claim 1, wherein
said gas supplying means is provided inside said first electrode, and said gas exhausting means is provided inside said second electrode.

3. The plasma processing apparatus according to claim 2, wherein
around said gas supplying means and said gas exhausting means, an inner wall formed of a dielectric material is provided.

4. The plasma processing apparatus according to claim 1, wherein
the coated surfaces of said first and second electrodes, respectively, extend on a plane parallel to the surface of the object.

5. The plasma processing apparatus according to claim 1, wherein
an electric line of force connecting said first and second electrodes when a voltage is applied between said first and second electrodes extends above and substantially parallel to the surface of the object.

6. The plasma processing apparatus according to claim 1, wherein
said supply opening and said exhaust opening are provided in a vicinity of a region positioned between said first opposing surface and said second opposing surface.

7. The plasma processing-apparatus according to claim 1, wherein
said dielectric includes a recessed portion formed such that distance from the surface of the object to said second opposing surface is made larger than distance from the surface of the object to said first opposing surface.

8. The plasma processing apparatus according to claim 1, wherein
said supply opening and said exhaust opening are formed to have a slit-shape extending in one direction or formed as a plurality of pores arranged in one direction.

9. The plasma processing apparatus according to claim 1, wherein
said gas supplying means and said gas exhausting means are formed such that total flow rate of gas exhausted through said exhaust opening is not smaller than total flow rate of the processing gas supplied through said supply opening.

10. The plasma processing apparatus according to claim 1, wherein
at that portion of said dielectric which faces the surface of the object, where distance between an end portion of said dielectric positioned at a shortest distance from said supply opening and said supply opening is represented by L1, distance between said supply opening and said exhaust opening is represented by L2, and distance between said exhaust opening and an end portion of said dielectric positioned at a shortest distance from said exhaust opening is represented by L3, L1, L2 and L3 satisfy the relations of 4≦L1/L2≦1000 and 4≦L3/L2≦1000.

11. The plasma processing apparatus according to claim 1, further comprising
a grounded conductive cover provided to cover externally exposed surfaces of said first and second electrodes.

12. The plasma processing apparatus according to claim 1, further comprising
a third electrode positioned next to said second electrode on a side opposite to said first electrode with respect to said second electrode,
said apparatus being formed in symmetry with respect to said second electrode.
